(19) United States
(12) Patent Application Publication
(10) Pub. No.: US 2007/0292104 A1
(43) Pub. Date: Dec. 20, 2007

(54) Video Recording and Reproducing Apparatus

(76) Inventors: Yuichi Katano, Yokohama (JP); Keiji Nagayama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/762,247

(22) Filed: Jun. 13, 2007

(30) Foreign Application Priority Data
Jun. 14, 2006 (JP) 2006-164173

(51) Int. Cl. H04N 5/93

(52) U.S. Cl. 386/52

(57) ABSTRACT

A user can easily confirm how many scenes are to be recorded on a single DVD before dubbing starts when data of all scenes in a hard disk device is dubbed onto a DVD. A recording and reproducing apparatus including: a reproducing module which reproduces information from a first recording medium; a recording module which records information on a second recording medium; a selecting module which selects information to be dubbed onto the second recording medium out of information in the first recording medium according to format mode compatibility with the second recording medium when information is dubbed from the reproducing module onto the recording module; and a confirming module which displays information selected by the selecting module to allow confirmation of the information.

### CROSS REFERENCE TO RELATED APPLICATION

This application relates to and claims priority from Japanese Patent Application No. 2006-164173, filed on Jun. 14, 2006. The entirety of the contents and subject matter of all of the above is incorporated herein by reference.

1. Technical Field

The present invention relates to a video recording and reproducing apparatus for recording and reproducing video data, and in particular, to a function to dub data between recording media.

2. Background Art

Patent Documents 1 Japanese Unexamined Patent Application Publication No. 2005-277958 and 2 Japanese Unexamined Patent Application Publication No. 2005-182864 can be cited as background art in the present technical field.

Patent Document 1 describes in its abstract: (Problems to be Solved); To enable easy generation of a recording medium recording an imaging data, and (Solution); A digital video camera 11 includes a connector 16 on the camera side, being recessed on a side face 12a of a body 12, and records the imaging data into a hard disc unit. A recording apparatus 20 can be connected directly to the video camera 11 through a connector 21 disposed on the side face. The recording apparatus 20 fetches the imaging data of the selected image and records the fetched imaging data into an optical disc d (refer to abstract).

Patent Document 2 describes in its abstract: (Problems to be Solved); To write the large-size video data in a storage device by automatically dividing the size of video data to be stored in the residual capacity of a recording medium when the size of original data is larger than the residual capacity of the recording medium of a writing destination,” and (Solution); When the large-size data of the copying source of an HDD 16 compared with the residual capacity of a DVD 18 is copied to the DVD 18, the residual capacity of the DVD 18 in which the residual capacity is recorded is detected, and copied to the DVD 18. In this case, for each division and copying of the copy source data of the HDD 16, division information indicating a copied state is created in a corresponding table corresponding to the copy source data. Then, during next copying, when a data part subsequent to the previous division and copying is copied to another recording medium, the copy source data is divided and copied from the position of the previous division information (refer to abstract). Furthermore, Paragraph 0035 states that, in FIG. 3, when a copy button of a remote control which is not shown is operated when data is copied to the DVD selected, a CPU 11 reads residual capacity information held by a DVD 18 (Step S1) and compares the data quantity of the HDD of copy source with the residual capacity of the DVD to which data is copied (Step S2). If the quantity of a series of data on the HDD side is smaller than the residual capacity on the DVD side, a series of all data on the HDD side is copied to the DVD 18 (Step S5).

### DISCLOSURE OF THE INVENTION

Problems to be Solved by the Invention

A DVD camera with an optical disc such as a DVD used as a recording medium of video data has appeared and extended its market because it is faster in search of recorded scene by random access and easy to use, for example, it prevents overwriting by recording video data on a place on which nothing has been recorded.

On the other hand, a hard disc camera provided with a hard disc used as a recording medium of video data has appeared as a small hard disc device has been increasing in recording capacity. Being expensive, a small hard disc device is typically built in a camera.

In such a hard disc camera, a built-in hard disc device is small in size and not so much larger in recording capacity. When all capacity has been used for recording, nothing can be recorded anymore, so that a recorded scene needs to be erased if hard disk space is required for subsequent recording. However, some recorded scenes can never be recorded again (if erased) such as records concerning children's growth and the like. For this reason, the hard disc camera is connected to an external apparatus such as a DVD recorder or PC to dub the data recorded in the hard disc camera onto the DVD or the like, thereafter the data on the scenes in the hard disc device is erased. The recorded images in the hard disc camera can be reproduced only on the camera which has recorded the images. When the images need to be reproduced on a home television set or at a remote area, they are dubbed onto a DVD. However, it is troublesome to connect the hard disc camera to an external apparatus, which is inferior in operability. In addition, for example, if a person who took pictures of his/her children went to hometown and took a hard disc camera with him/her without a cable, images cannot be reproduced, so that they cannot be shown to anyone in the hometown.

When the recorded images in the hard disc camera are dubbed onto an external apparatus, data on all scenes recorded in the hard disc is dubbed onto a DVD. In Patent Documents 1 and 2, however, it was not known that which scenes had been dubbed onto a DVD.

There has been a request from a user to view scenes to be recorded on each DVD. For example, when eleven scenes composed often scenes captured in the morning session of an athletic meeting and one out of eight scenes captured in the afternoon session thereof are dubbed, there has been a request from a user to, for example, edit them depending on a combination of scenes without directly dubbing them. In this respect, a conventional art has not considered the automatic selection and display of scenes to be dubbed on each DVD, so that a user cannot easily confirm which scenes are to be recorded onto each DVD before dubbing starts, which causes a problem in that the video camera is not user-friendly.

As described in Patent Document 2, the automatic division of the scenes produces a problem in that data divided at user's unintended position (for example, between start and goal of a footrace in an athletic meeting) is dubbed into another DVD. Particularly, most scenes captured by a camera are shorter in time period than broadcast programs, so that it is convenient to compile such shorter scenes for each associated scene rather than divided.

There is another non user-friendly problem in that there are various restrictions on dubbing onto different recording media and a user cannot confirm in advance as to whether data can be dubbed.

Means for Solving the Problems

For example, when data is dubbed from a first medium (for example, a hard disc) onto a second medium (for example, an optical disc), data which can be recorded onto the single second medium is automatically selected and displayed before dubbing.

For example, messages are displayed as to whether data can be dubbed according to kinds of recording media onto which data is dubbed or a combination of data to be dubbed.

Effects of the Invention

According to the above means, a user can confirm which data can be dubbed or whether dubbing is enabled, thereby a user can easily dub without anxiety.

Embodiments described below make apparent problems to be solved, means and effects except the abovementioned.

Examples of embodiments for carrying out the present invention are described hereinunder. A description is made using a digital video camera (hereinafter, simply referred to as video camera) incorporating a hard disc drive (hereinafter, referred to as HDD) and a digital versatile disc (DVD) drive as a video recording apparatus.

The present invention is advantageous in particular to a video camera required to meet such demands as: one scene may be shorter than broadcast program because imaging and stopping are frequently repeated; data is stored probably in the order of recording unlike broadcast programs (on the other hand, broadcast programs may be recorded in blocks of the same drama rather than in the order of recording); a simple operability is required because parents who are not used to handling frequently image their children; a larger sized hard disc is difficult to incorporate in terms of portability; and captured video data needs to be easily reproduced by a player. The present invention is also advantageous to other apparatuses such as a stable DVD recorder.

The present invention is not limited to a DVD, it may be applicable to other optical discs such as, for example, a blue-ray disc (BD) or a high definition (HD)-DVD. It is not limited to a combination of a HDD and an optical disc, but may be applicable to a combination of, for example, a HDD and a semiconductor memory, and an optical disc and a semiconductor memory.

### BRIEF DESCRIPTION OF THE DRAWINGS

FIG. 1 shows an example of configuration of a video camera.

FIG. 2 shows an example of selection of data to be dubbed.

FIG. 3 shows the flow of the whole process at the time of dubbing all scenes in a video camera.

FIG. 4 shows the flow of a dubbing advance check at the time of dubbing all scenes in the video camera.

FIG. 5 shows the flow of a dubbing scene automatic selection at the time of dubbing all scenes in the video camera.

FIG. 6 shows an example of a navigation screen display in HDD mode.

FIG. 7 shows an example of a screen indicating that dubbing scenes are being automatically selected.

FIG. 8 shows an example of a display of a dubbing confirmation screen.

FIG. 9 shows an example of a display of a selection scene confirmation screen.

FIG. 10 shows an example of a screen indicating that dubbing is being performed.

FIG. 11 shows an example of display of DVD taken-out confirmation screen.

FIG. 12 shows an example of display of a dubbing continuous confirmation screen.

FIG. 13 shows an example of display of a disk insertion request screen.

FIG. 14 shows an example of display of a dubbing failure screen.

FIG. 15 shows an example of display of a dubbed scene deleting confirmation screen.

FIG. 16 shows an example of display of a dubbing confirmation screen after replacing DVD.

FIG. 17 shows an example of display of a selection scene confirmation screen after replacing DVD.

FIG. 18 shows an example of display of an adaptor alarm screen.

FIG. 19 shows an example of display of a DVD initialization confirmation screen.

FIG. 20 shows an example of displaying a scene selection screen.

FIGS. 21(a) and 21(b) show an example appearance of a video camera.

FIG. 22 shows an example of display of a dubbing confirmation screen in the second embodiment.

FIG. 23 shows an example of display of a dubbing confirmation screen in the third embodiment.

FIG. 24 shows an example of display of a dubbing confirmation screen in the fourth embodiment.

### DETAILED DESCRIPTION OF THE DRAWINGS

First Embodiment

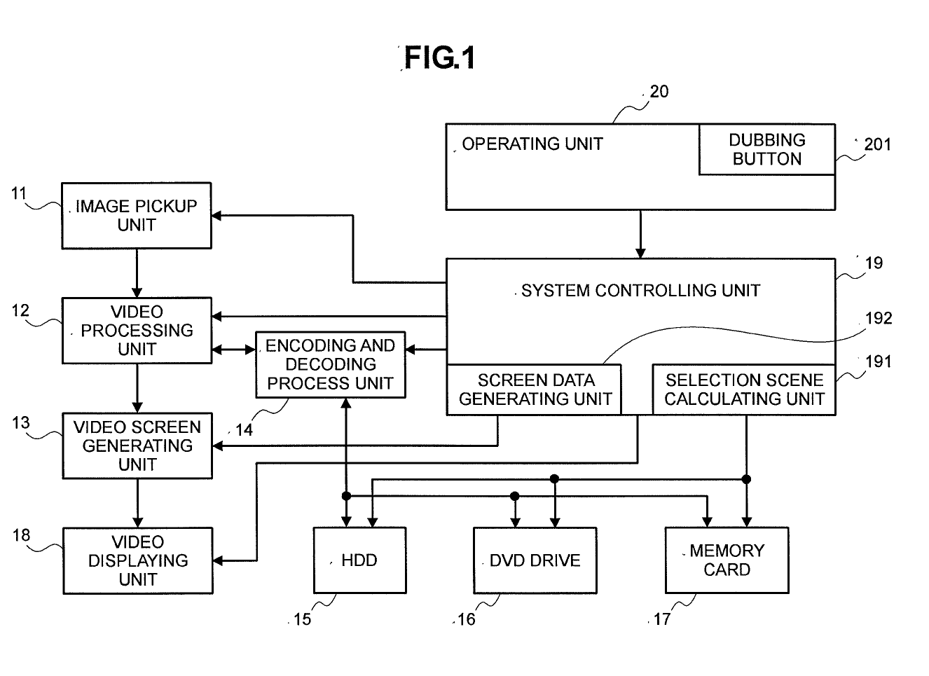

The first embodiment is described with reference to FIGS. 1 to 21.

(1) Outline of Configuration

FIG. 1 is a block diagram illustrating an example of configuration of a video camera.

In an image pickup unit 11 for picking up images, the zoom and iris of lens therein are controlled by a system controlling unit 19. Picked up images are converted into electric signals by an imaging (charge coupled device (CCD)) sensor or a complementary metal oxide semiconductor (CMOS) sensor. Noises are removed and the signals are amplified and then converted into digital signals.

The digital signals output from the image pickup unit 11 are subjected to various signal processing such as noise reduction in a video processing unit 12 to turn into a digital video signal. The digital video signal output from the video processing unit 12, on which a character data is superposed in a video screen generating unit 13, is sent to a video displaying unit 18 such as a liquid crystal display (LCD) or an electric view finder (EVF) for displaying video signals to be captured. The video displaying unit 18 may use displays such as an electro luminescence display (ELD) instead of an LCD. The LCD or EVF of the video displaying unit 18 are sometimes referred to as a side displaying unit and finder unit, respectively.

The digital signal output from the video processing unit 12 is also sent to an encoding and decoding process unit 14 and compressed and encoded by a moving picture experts group 2 (MPEG 2) system if the signal is a moving picture and then stored in a HDD 15 of a first recording unit or a DVD drive 16 of a second recording unit according to selection modes.

If the signal is a still picture, the signal is compressed by a joint photographic experts group (JPEG) system and recorded in a memory card 17. Thus, the video camera is equipped with two recording units capable of recording moving pictures; HDD 15 and DVD drive 16. In the present embodiment, the HDD 15 is one inch in diameter and has a recording capacity of 8 GB and the DVD drive 16 is capable of driving an 8-cm DVD. The 8-cm DVD of, for example, a DVD-RAM (random access memory) is about 1.4 GB in recording capacity per layer.

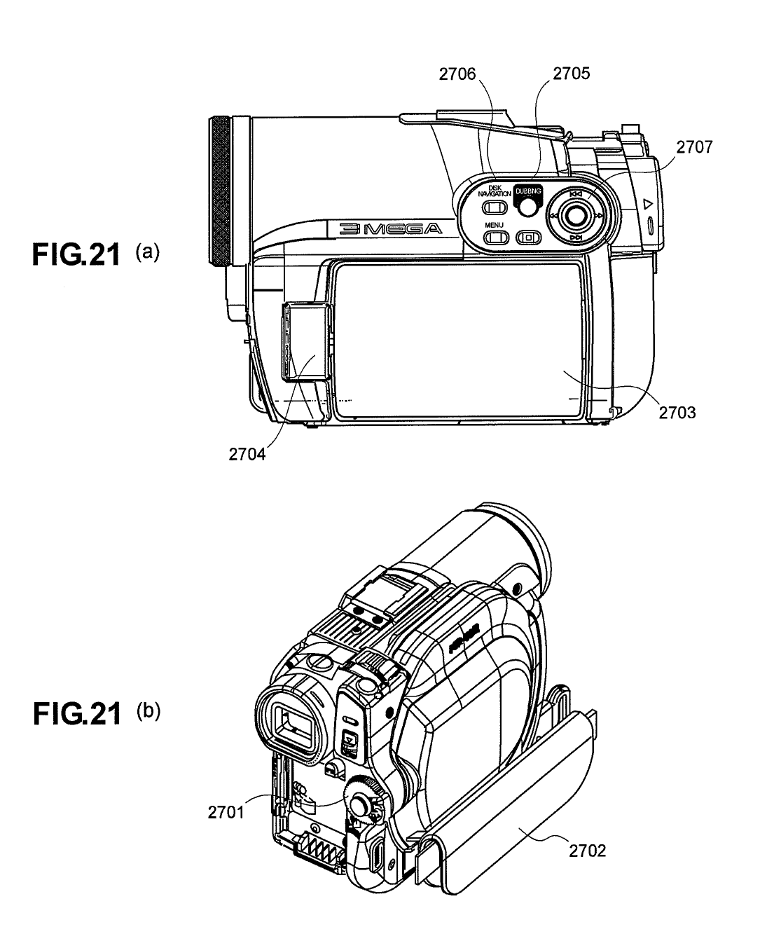

The whole video camera is controlled by a system control unit 19. Various operations and data input are performed by users though an operating unit 20. An example of layout of the operating unit 20 is described with reference to FIG. 21(a).

FIG. 21(a) shows an example of appearance of a video camera. FIGS. 21(a) and 21(b) are a side front view and rear perspective view thereof respectively.

A power-supply/mode changeover switch 2701 for changing over power supply on/off and modes is arranged on the rear portion of the video camera (operator's side) to be operated by operator's thumb with the camera held with operator's hand passing inside a belt 2702.

An LCD portion (side display portion) 2703 of the video displaying unit 18 housing an LCD and an LCD supporting portion 2704 lie on the left side portion. The LCD supporting portion 2703 is capable of opening, closing and rotating the LCD portion 2703 and even cause the LCD portion 2703 to face outward (in FIG. 21(a), the LCD portion 2703 is turned upside down on the paper surface side). Furthermore, the video camera includes on its left side portion, a dubbing button 2705 (reference numeral 201 in FIG. 1) for starting an automatic operation dubbing from the HDD 15 to a DVD inserted into the DVD drive 16, a disc navigation button 2706 for displaying a navigation screen and cursor 2707.

When the LCD portion 2703 is opened and the LCD display portion faces outward, the dubbing button 2705, the disc navigation button 2706 and the cursor 2707 are on the same side as the screen, which make it easy to use in dubbing operation.

(2) Operation in Brief

Operation is briefly described with reference to FIGS. 1, 2 and 21 for the case where dubbing is performed from the HDD 15 to a DVD inserted into the DVD drive 16.

Turning the power supply and HDD mode on through the operation of the operation unit 20 and pressing the disc navigation button 2706 in FIG. 21 cause a screen data generating unit 192 to read thumbnail picture data of the scenes stored in the HDD 15, generate a list of thumbnail screen data and send it to the video screen generating unit 13. The video screen generating unit 13 generates a thumbnail screen (navigation screen) based on a list of thumbnail screen data and displays it on the LCD of the video displaying unit 18.

In this state, users depressing a dubbing button 201 of the operating unit 20 causes the system controlling unit 19 to detect that the dubbing button 201 has been depressed and start an automatic all selection dubbing process for dubbing all scenes stored in the HDD 15 onto a DVD loaded into the DVD drive 16.

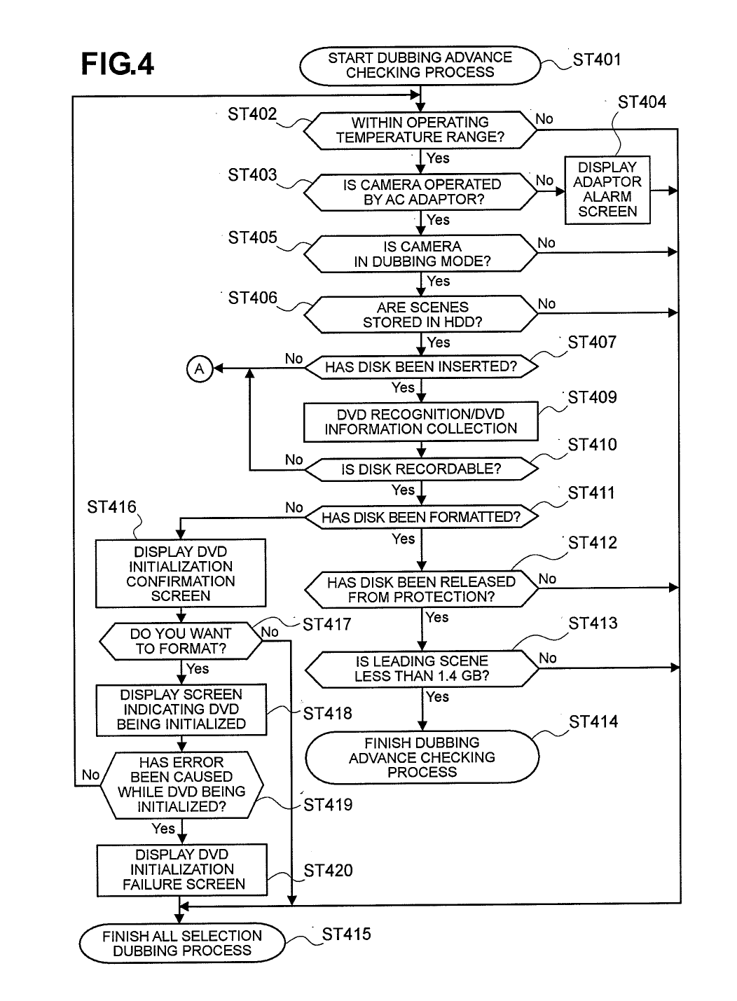

The system controlling unit 19 collects data of the HDD 15 and the DVD loaded into the DVD drive 16 and ascertains whether recording is enabled or the video camera is put in dubbing mode (further details described in a dubbing advance check process in FIG. 4).

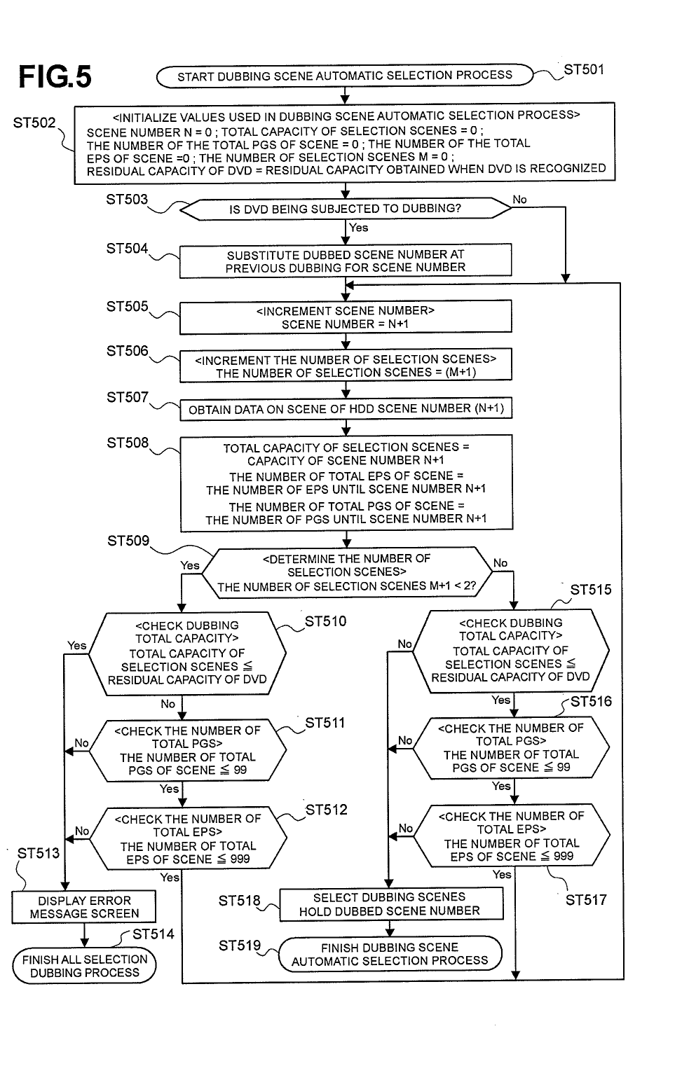

After that, a selection scene calculating unit 191 selects scenes which can be recorded onto the loaded DVD based on data such as the number of scenes and the quantity of data stored in the HDD 15 and the residual recording capacity of the DVD loaded into the DVD drive 16 (further details described later in dubbing scene automatic selection in FIG. 5). The selection scene calculating unit 191 selects a scene whose data quantity is smaller than the residual capacity of the DVD loaded out of the scenes stored in the HDD 15 in the order of recording as a scene to be dubbed.

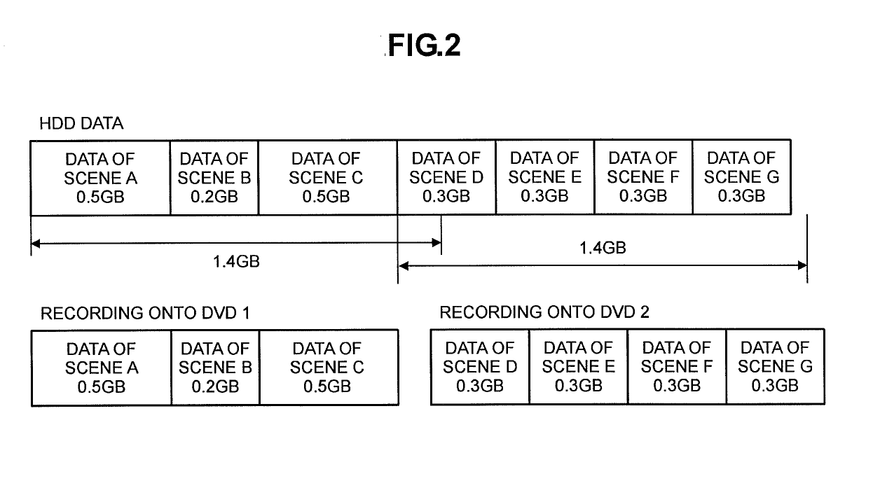

FIG. 2 shows an example of selection of scenes to be dubbed according to the present embodiment. An example of selection of dubbed scenes by the selection scene calculating unit 191 is described with reference to FIG. 2. Where, the residual capacity of the DVD is 1.4 GB, the data quantity of a scene A stored in the HDD 15 is 0.5 GB, that of a scene B is 0.2 GB, that of a scene C is 0.5 GB and that of scenes D, E, F and G is 0.3 GB.

Depressing the dubbing button 201 causes automatic selection of data of a scene to be dubbed onto the loaded DVD 1 out of data stored in the HDD starting from the initial scene A within the residual capacity of the DVD 1. Where, the total capacity of the scenes A, B and C is 1.2 GB and is not greater than 1.4 GB of the DVD. The total capacity of the scenes A, B, C and D is 1.5 GB which is more than 1.4 GB of the DVD, so that the scenes A, B and C are selected as the scenes to be dubbed.

When the following DVD 2 is loaded after dubbing onto the DVD 1 has been finished, data is selected out of the data starting from the initial scene D to the subsequent scenes which have not been dubbed within the residual capacity of the DVD 2. The total capacity of the scenes D, E, F and G is 1.2 GB and is not greater than 1.4 GB of the DVD, so that the scenes D, E, F and G are selected as the scenes to be dubbed.

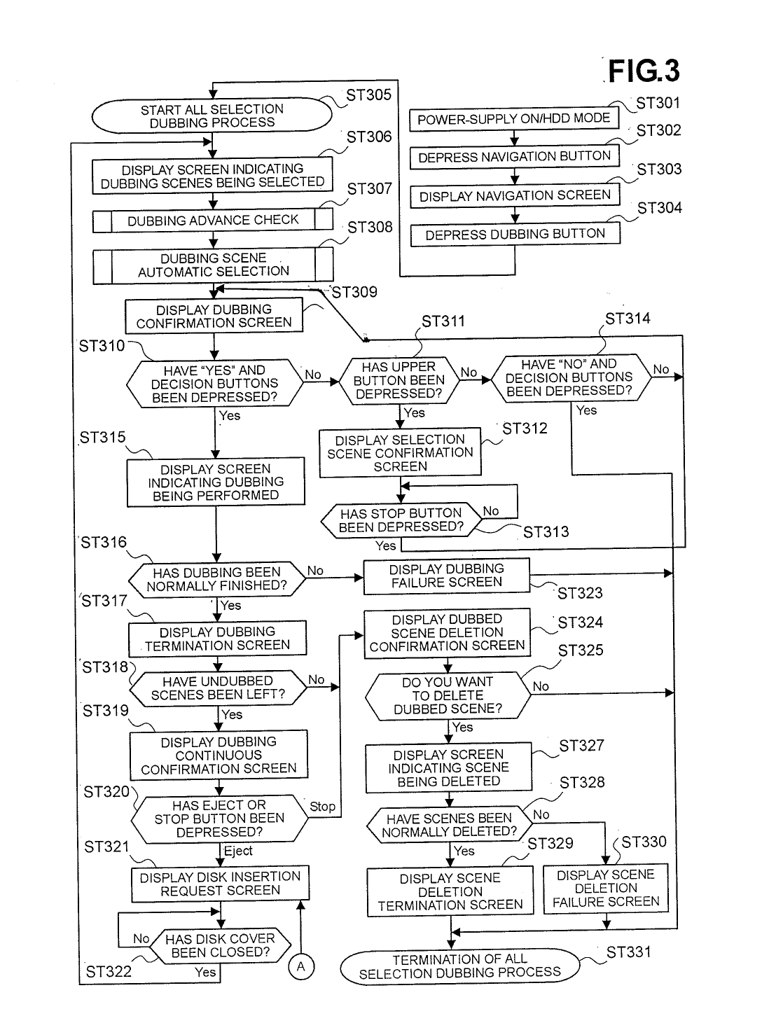

When the candidate scenes to be dubbed have been automatically selected by the selection scene calculating unit 191, the screen data generating unit 192 reads thumbnail picture data corresponding to the candidate scenes to be dubbed in the HDD 15, generates dubbing confirmation screen data composed of displays for confirming the execution of dubbing operation and thumbnail pictures of the scenes to be dubbed and sends it to the video screen generating unit 13. The video screen generating unit 13 generates a dubbing confirmation screen based on the dubbing confirmation screen data and displays it on the video displaying unit 18 (Step 309 in FIG. 3).

After that, when it has been determined that dubbing operation is continued, data of the selected scenes is read from the HDD 15, an operation starts of dubbing onto the DVD loaded into the DVD drive 16. When all scenes stored in the HDD 15 have been dubbed, the screen data generating unit 192 generates a dubbed-scene deletion-confirmation screen data and displays a dubbed-scene deletion-confirmation screen on the video displaying unit 18 via the video screen generating unit 13 (Step 324 in FIG. 3).

Executing deletion on the dubbed-scene deletion-confirmation screen erases data of the dubbed scenes from the HDD 15. The all selection dubbing process is terminated and the screen returns to the original navigation screen.

When the scenes that have not yet been dubbed are left in addition to the scenes to be dubbed after the selected scenes to be dubbed have been dubbed onto a first DVD, the screen data generating unit 192 generates a dubbing continuous confirmation screen data requesting the DVD to be replaced to continue dubbing onto a second DVD, and displays a dubbing continuous confirmation screen on the video displaying unit 18 via the video screen generating unit 13 (Step 319 in FIG. 3).

When a user replaces the first DVD with the second one, as is the case with the first DVD, the system controlling unit 19 ascertains whether the video camera is put in dubbing mode, the selection scene calculating unit 191 selects scenes that can be recorded on the second DVD, and the screen data generating unit 192 generates dubbing confirmation screen data and displays the dubbing confirmation screen on the video displaying unit 18 via the video screen generating unit 13. Subsequently, such a process is repeated until the scenes in the HDD 15 that have not been dubbed are reduced to zero to dub data of each scene onto the DVD.

In the present embodiment, as described above, only depressing the dubbing button 201 at the time of dubbing from the HDD 15 to the DVD automatically displays the thumbnail pictures of scenes to be recorded on one DVD. This enables a user to easily confirm which scenes are recorded on one DVD before dubbing starts. Furthermore, a dubbing confirmation display and thumbnail pictures appear on the screen at the same time, so that, if a displayed thumbnail picture is unwanted, dubbing can be immediately stopped, which make it easy to use for a user. In addition to the above, providing the dubbing button 201 on the video camera body allows dubbing to start without a remote control unit, which is user-friendly.

(3) Operation in Detail

The above dubbing flow executed by the video camera is described in detail with reference to flow charts and examples of screen displays in FIGS. 3 to 20. In the following example, seven scenes are assumed to have been recorded on the HDD 15.

FIG. 3 is a flowchart showing the flow of the all scene dubbing process. FIG. 4 is a flowchart showing the flow of the dubbing advance checking process at step 307 in FIG. 3. FIG. 5 is a flowchart showing the flow of the dubbing scene automatic selection process at step 308 in FIG. 3. The order of steps of the flowcharts is replaceable and the steps can be increased or decreased. Unless otherwise specified, the system controlling unit 19 (including the selection scene calculating unit 191 and the screen data generating unit 192) executes the flowcharts and is referred to as selection unit, confirmation unit or power supply monitoring unit according to its function.

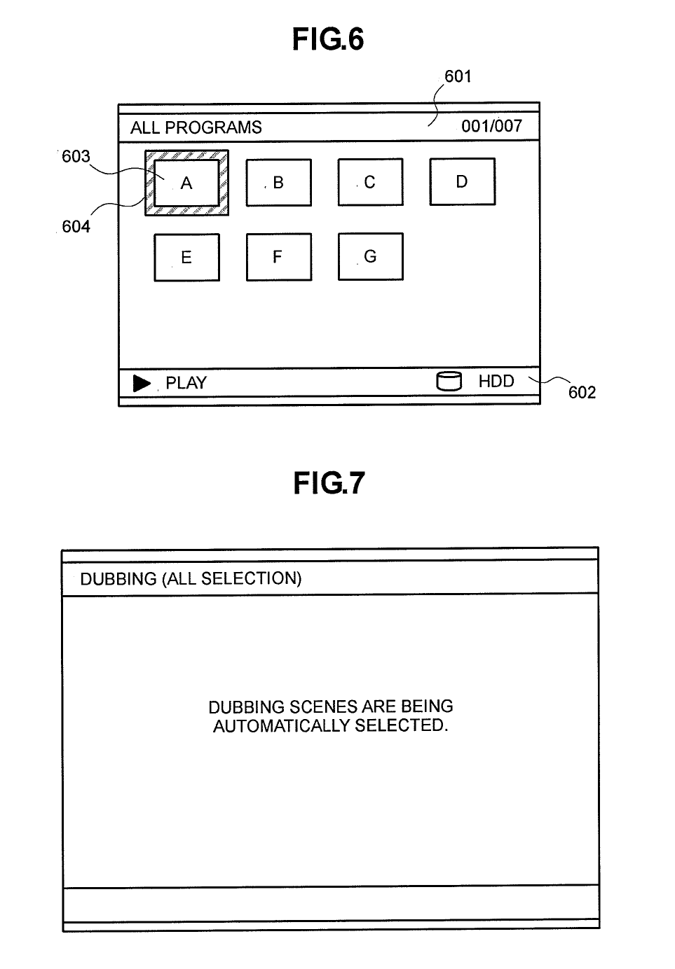

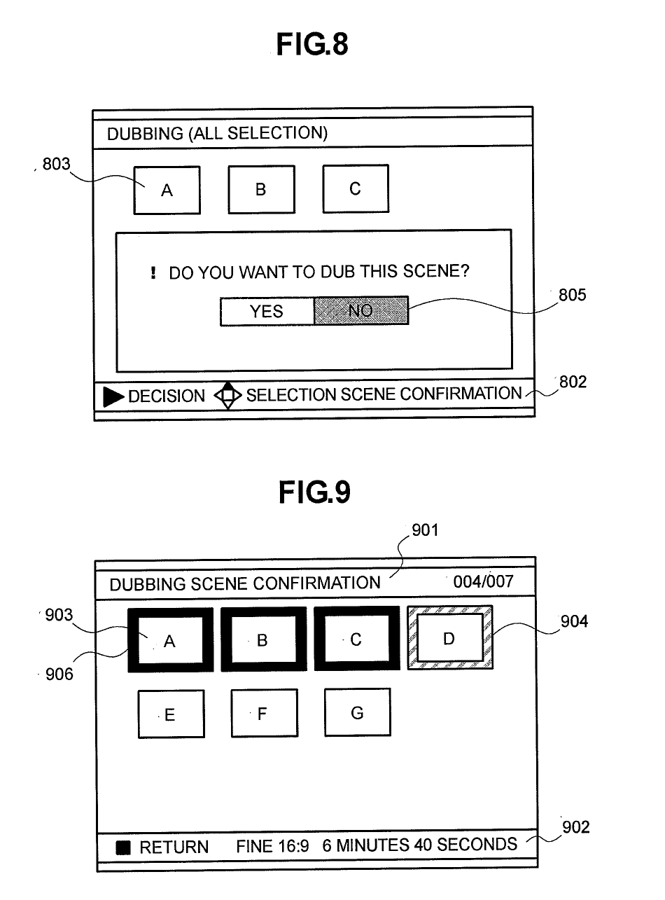

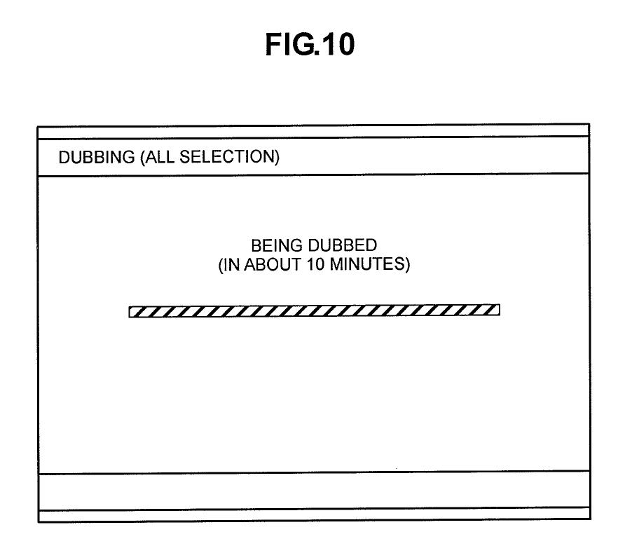

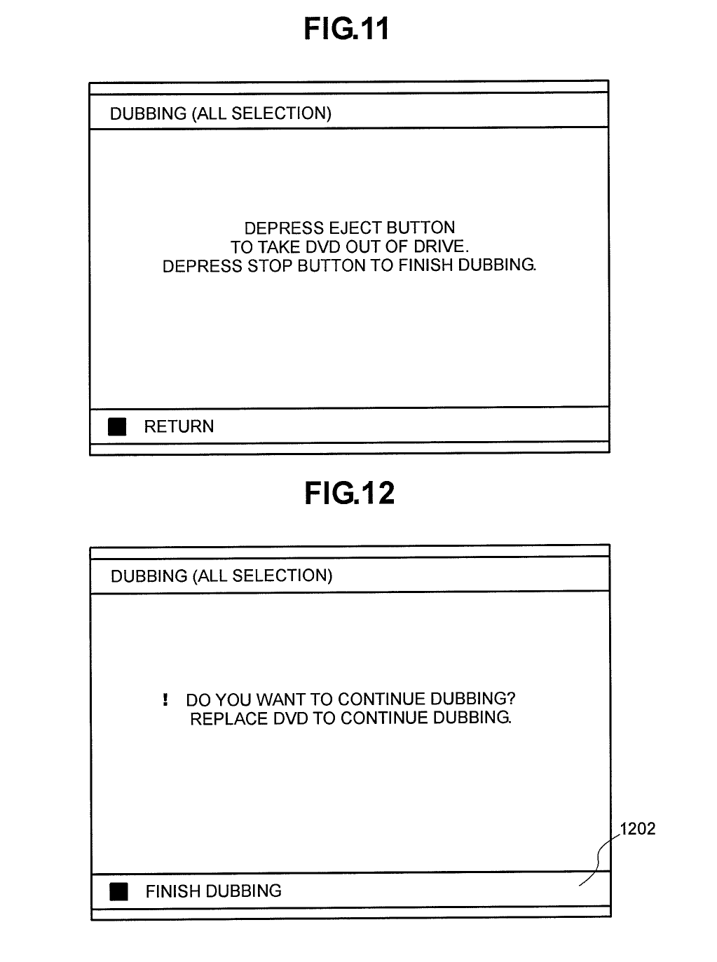

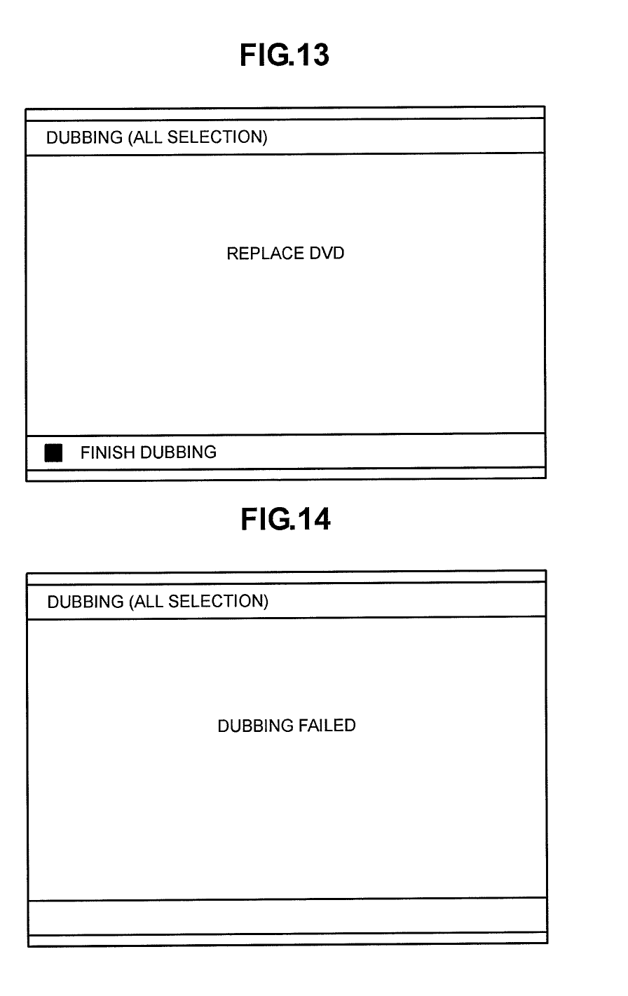

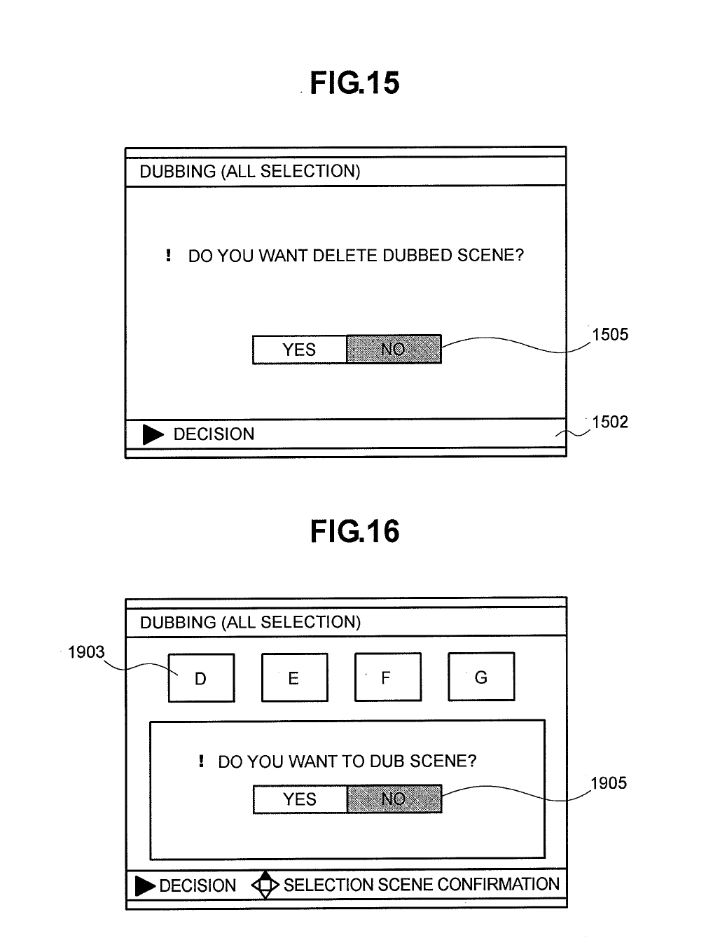

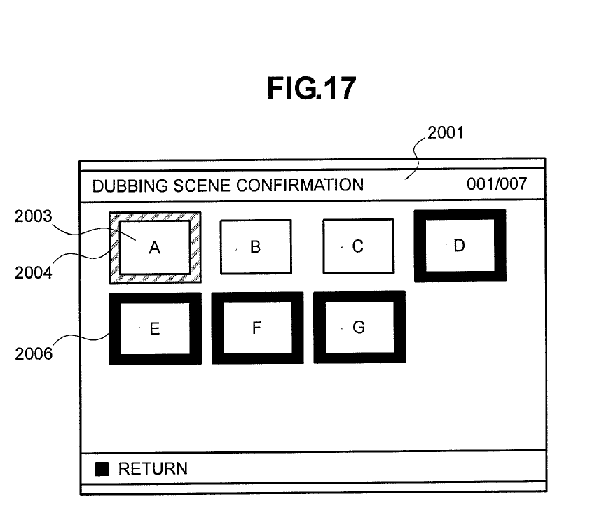

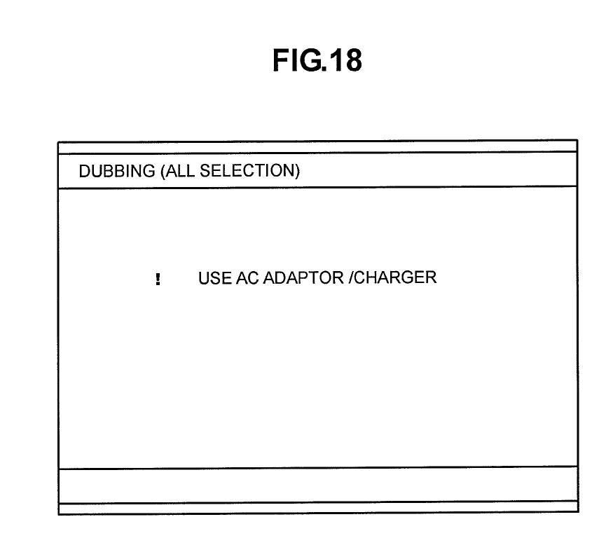

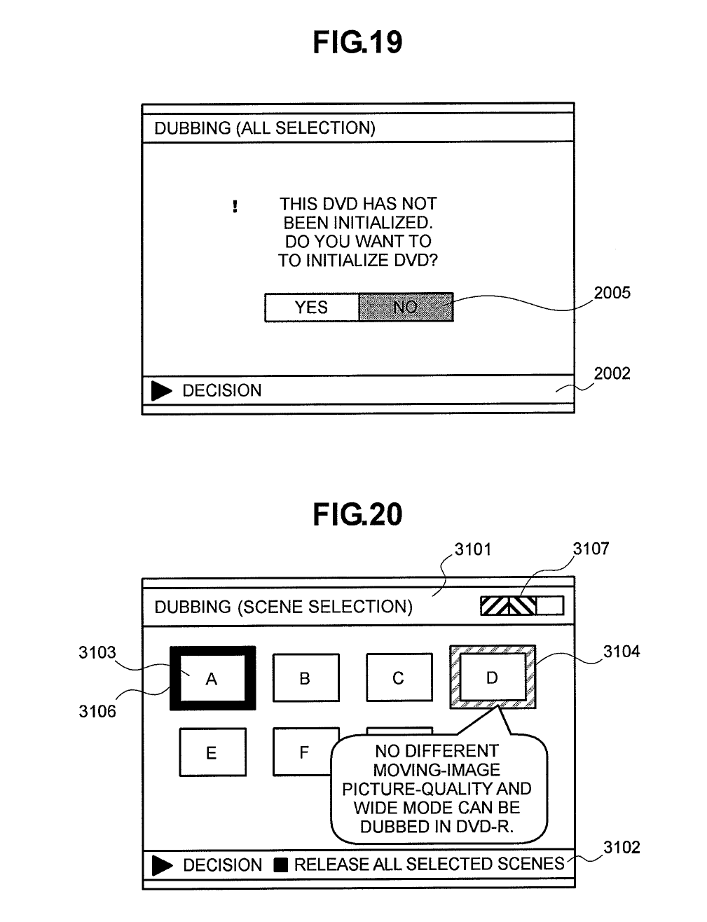

FIG. 6 is an example of a navigation screen in HDD mode. FIG. 7 is an example of screen display indicating that dubbing scenes are being selected. FIG. 8 is an example of display of a dubbing confirmation screen. FIG. 9 is an example of display of a selection scene confirmation screen. FIG. 10 is an example of screen display indicating that scenes are being dubbed. FIG. 11 is a DVD taken-out confirmation screen. FIG. 12 is an example of display of a dubbing continuous confirmation screen. FIG. 13 is an example of display of a disk insertion request screen. FIG. 14 is an example of display of a dubbing failure screen. FIG. 15 is an example of display of a dubbed scene deleting confirmation screen. FIG. 16 is an example of a dubbing confirmation screen displayed after a DVD has been replaced. FIG. 17 is an example of a selection scene confirmation screen displayed after a DVD has been replaced. FIG. 18 is an example of display of an adaptor alarm screen. FIG. 19 is an example of display of an initialization confirmation screen. FIG. 20 is an example of display of a scene selection screen.

(3-1) All Scene Dubbing Process

The power-supply/mode changeover switch 2701 in FIG. 21 in the operating unit 20 puts the HDD 15 in HDD mode to operate as a recording medium at step 301 (hereinafter, a step is expressed as “ST” in the figures). Depressing the disc navigation button 2706 in the operating unit 20 at step 302 displays a list (navigation screen) of thumbnail pictures of scenes stored in the HDD 15 at step 303 as illustrated in FIG. 6.

The central portion of the navigation screen in FIG. 6 displays thumbnail pictures 603 (A to G) of representative scenes and a yellow frame 604 (striped area in the figure) for indicating the selected thumbnail picture. A title bar 601 at the upper portion of the screen displays “All Programs” denoting the title of the screen, “007” indicating the number of the all scenes and “001” representing the number of the thumbnail picture 603 A selected at present. An operation guide 602 at the lower portion of the screen displays a play-button icon for viewing the scenes of the selected thumbnail pictures and a HDD icon of the recording source of the present navigation screen.

When the depression of the dubbing button 201 is detected at step 304, the all selection dubbing process starts at step 305. At step 306, a dubbing automatic selection screen in FIG. 7 indicating that scenes to be dubbed are automatically being selected is displayed. The process proceeds to the dubbing advance checking process at step 307.

Incidentally, even if the navigation button is not depressed at step 302, the dubbing button 201 is depressed, for example, while images are being picked up (or, during a “camera through” in which picked up images are being displayed on an image displaying portion) to display the screen of the FIG. 7. Even if the dubbing button 201 is not depressed and if “scene automatic selection” is executed through menu selection operation from step 303, the step 305 is also executed.

At step 307, a confirmation is made in advance as to whether data can be recorded on the DVD loaded into the DVD drive 16 based on information from the DVD, scenes have been recorded on the HDD 15, and the video camera has been put in dubbing mode based on such information as the operation states of the video camera. If it is determined that the video camera has been put in dubbing mode at step 307, the process advances to a dubbing scene automatic selection process of step 308.

At step 308, the scenes to be dubbed which are recorded on the loaded DVD are selected based on data such as the number of the scenes stored in the HDD 15, data quantity therein and residual capacity of the DVD loaded into the DVD drive 16. At this point, as described in FIG. 2, the scenes A to C are selected as the scenes to be dubbed onto the first DVD. Thus, even in a state where scenes are not selected, the dubbing button 201 is depressed to automatically select a plurality of scenes which can be recorded on one DVD.

At step 308, the scenes to be dubbed are selected. At step 309, the dubbing confirmation screen in FIG. 8 is displayed. The central portion of the dubbing confirmation screen displays thumbnail pictures 803 (A to C) corresponding to the scenes A to C selected as the scenes to be dubbed and a dubbing confirmation display 805 for ascertaining the execution of dubbing operation. An operation guide 802 at the lower portion of the screen displays a play button icon for determining whether to continue a dubbing operation and a cursor-upper-button icon for confirming the selected scenes. A user views the dubbing confirmation screen to determine whether the selected scenes are wanted and then can continue or stop dubbing. Thus, only depressing the dubbing button 201 enables automatically displaying the thumbnail pictures of the scenes to be recorded on one DVD. This enables a user to easily confirm which scenes are recorded on one DVD before dubbing starts. Furthermore, a dubbing confirmation display and thumbnail pictures appear on the screen at the same time, so that, if a displayed thumbnail picture is unwanted, dubbing can be immediately stopped, which make it easy to use for a user.

When a user determines whether the selected scene is wanted one to continue dubbing in the dubbing confirmation screen at step 309, the user selects “Yes” of the dubbing confirmation display 805 with the cursor button 2707 in FIG. 21(a) of the operating unit 20 and depresses a determination button at step 310. When dubbing needs stopping, “No” of the dubbing confirmation display 805 is selected and a decision button is depressed at step 314 to finish the all selection dubbing process at step 331 and then the process returns to the initial navigation screen.

If all the scenes to be dubbed are not displayed or all the scenes excluding those need confirming in the dubbing confirmation screen at step 309, the selection scene confirmation button is depressed to display the selection scene confirmation screen at step 312 as illustrated in FIG. 9. The central portion of the screen displays thumbnail pictures 903 (A to G) of all the scenes, a red frame 906 (printed in black in the figure) showing the scenes to be dubbed, and a yellow frame 904 (striped area in the figure) indicating the selected thumbnail picture. A title bar 901 at the upper portion of the screen displays “dubbing scene confirmation” denoting the title of the screen, “007” expressing the number of all scenes and “004” indicating the number the currently selected thumbnail picture 903 D. An operation guide 902 at the lower portion of the screen displays a return button for finishing the dubbing scene confirmation display to return to the dubbing confirmation screen. The operation guide 902 at the lower portion of the screen also displays a picture quality “FINE” which is information on the selected scene D, aspect ratio “16:9” and recording time period “6 minutes 40 seconds” of the scene D, when the screen is put in a recording date display mode.

Depressing the stop button at step 313 causes the process to return to the dubbing confirmation screen of step 309. Thus, even if a large number of the scenes to be dubbed exist, a user can easily confirm them in advance.

Selecting “Yes” of the dubbing confirmation display 805 with the cursor button 2707 and depressing the decision button at step 310 displays a screen indicating that scenes are being dubbed at step 315 as illustrated in FIG. 10 to start a dubbing operation. A duration estimated from dubbing scene size, transfer rate and writing speed is calculated to display it on the screen. At step 316, determination is made as to whether dubbing has been normally finished. If it has not been normally finished, a dubbing failure screen indicating a failure in dubbing is displayed at step 323, the all selection dubbing process is finished at step 331 and the process returns to the initial navigation screen.

If it has been normally finished at step 316, a dubbing finish screen indicating the termination of dubbing is displayed at step 317. At step 318, determination is made as to whether the scenes that have not yet been dubbed are left exclusive of the scenes to be dubbed. If the scenes that have not yet been dubbed are not left, the process proceeds to step 324. At this point, the system controlling unit 19 needs memorizing in its memory that dubbing is continuous. If the scenes that have not yet been dubbed are left at step 318, a dubbing continuous confirmation screen is displayed for ascertaining whether to continuously dub onto a second DVD at step 319, as illustrating in FIG. 12. An operation guide 1202 at the lower portion of the screen displays a stop button icon for finishing dubbing.

At step 320, determination is made as to whether an eject button for continuing dubbing onto the second DVD or the stop button for finishing dubbing are depressed. At step 320, if it is determined that the stop button for finishing dubbing is depressed, the process advances to step 324.

At step 320, if it is determined that the eject button for continuing dubbing onto the second DVD is depressed, the disk insertion request screen requesting to replace the first DVD with the second DVD is displayed at step 321 as shown in FIG. 13. At step 322, it is ascertained whether the second DVD is inserted into the DVD drive 16 and a disk cover is closed. Then, at step 306, the screen indicating that dubbing scenes are automatically being selected is displayed. In this way, steps 306 to 322 are repeated until the scenes that have not been dubbed are reduced to zero. Depressing the “Finish Dubbing” button in FIG. 13 causes the process to advance to step 331 to terminate dubbing process.

If it is determined that scenes that have not been dubbed are not left at step 318 or the stop button for finishing dubbing is depressed at step 320, the dubbed-scene deletion-confirmation screen ascertaining whether to delete data of the dubbed scenes is displayed at step 324 as shown in FIG. 15. The central portion of the dubbed-scene deletion-confirmation screen provides a scene deletion confirmation screen display 1505 for ascertaining whether to erase data of the dubbed scenes from the HDD 15. An operation guide 1502 at the lower portion of the screen displays a decision button icon for determining whether to continue erasing data of the dubbed scenes. If a user does not want to erase data of the dubbed scenes from the HDD 15 in the dubbed-scene deletion-confirmation screen, selecting “No” of the scene deletion confirmation screen display 1505 by the cursor button 2707 and determining at step 325 finish the all selection dubbing process at step 331 and the process returns to the initial navigation screen. Incidentally, if determination is made before dubbing starts (for example, after step 310) whether to delete the stored scenes in the HDD 15 after dubbing has been normally finished, dubbing and deleting are automatically completed, thereby a user has to do nothing after instructing dubbing, which is very convenient.

At step 331, a DVD ejection confirmation screen shown in FIG. 11 is displayed to notify a user that the DVD can be taken out of the drive.

Selecting “Yes” of the scene deletion confirmation screen display 1505 by the cursor button 2707 and determining at step 325 display the scene deletion confirmation screen indicating that data of the dubbed scenes are being erased at step 327. At step 328, it is determined whether data of the dubbed scenes has been normally deleted from the HDD 15. If data is normally deleted, a scene deletion finish screen is displayed indicating that the scenes have been deleted at step 329. At step 331, the all selection dubbing process is finished and the process returns to the initial navigation screen. At this point, however, thumbnail pictures do not appear on the navigation screen because all the scenes are deleted from the HDD 15.

If data has not been normally deleted at step 328, the dubbing failure screen indicating a failure in dubbing is displayed at step 330, the all selection dubbing process is finished at step 331 and the process returns to the initial navigation screen. At this point, only thumbnail pictures of the scenes that have not been deleted are displayed.

At step 322, it is ascertained whether the second DVD is inserted into the DVD drive 16 and a disk cover is closed. Then, at step 306, the screen is displayed indicating that dubbing scenes are automatically being selected. Thereafter, at step 307, a confirmation is made in advance as to whether data can be recorded on the second DVD loaded into the DVD drive 16 based on information from the DVD, scenes have been recorded on the HDD 15, and the video camera has been put in dubbing mode based on such information as the operation states of the video camera. If it is determined that the video camera has been put in dubbing mode at step 307, the scenes to be dubbed which are recorded on the second loaded DVD are selected at step 308 based on data such as the number of the scenes which have not been dubbed and stored in the HDD 15, data quantity therein and residual capacity of the second DVD loaded into the DVD drive 16. At this point, as described in FIG. 2, the scenes D to G are selected as the scenes to be dubbed onto the second DVD.

At step 308, when the scenes to be dubbed onto the second DVD are selected, the dubbing confirmation screen as shown in FIG. 16 is displayed at step 309. The central portion of the dubbing confirmation screen provides thumbnail pictures 1903 (D to G) corresponding to the scenes D to G selected as the scenes to be dubbed and a dubbing confirmation display 1905 for ascertaining the execution of dubbing operation. If all the scenes to be dubbed are not displayed or all the scenes excluding those need confirming in the dubbing confirmation screen at step 309, the selection scene confirmation button is depressed to display the selection scene confirmation screen at step 312 as illustrated in FIG. 17. The central portion of the screen displays thumbnail pictures 2003 (A to G) of all the scenes, a red frame 2006 (printed in black in the figure) showing the scenes to be dubbed, and a yellow frame 2004 (striped area in the figure) indicating the selected thumbnail picture. A title bar 2001 at the upper portion of the screen displays “dubbing scene confirmation” denoting the title of the screen, “007” expressing the number of all scenes and “001” indicating the number the currently selected thumbnail picture 2003 A. Thus, the thumbnail pictures of the scenes to be dubbed are displayed for each DVD, so that, even if dubbing is performed onto a plurality of DVDs, the scenes which are dubbed onto the loaded DVD are easily confirmed, which makes it easy to use.

(3-2) Dubbing Advance Checking Process

A dubbing advance checking process at step 307 is described in detail with reference to FIG. 4. When the dubbing advance checking process starts at step 401, determination is made as to whether temperature in the video camera is within operating temperature range at step 402. If it is determined that temperature is outside the limits (“No” in step 402), a message of “outside the operating temperature range,” for example, is displayed. The all selection dubbing process is finished at step 415 and the process returns to the initial navigation screen. If it is determined that temperature is within the operating temperature range, the process proceeds to step 403.

At step 403, determination is made as to whether the camera is operated by a power supply from an alternate current (AC) adaptor. If it is determined that the camera is operated by a power supply from a battery instead of the AC adaptor, an adaptor alarm screen as shown in FIG. 18 is displayed to request a user to use an adaptor/charger at step 404. The all selection dubbing process is finished at step 415 and the process returns to the initial navigation screen. If it is determined at step 403 that the camera is operated by a power supply from the AC adaptor, the process proceeds to step 405.

At step 405, determination is made as to whether the video camera is put in dubbing mode. If it is determined that the video camera is not put in dubbing mode, for example, in recording and in initializing a DVD, the all selection dubbing process is finished at step 415 and the process returns to the initial navigation screen.

At step 405, if it is determined that the video camera is put in dubbing mode, determination is made as to whether there are scenes stored in the HDD 15 at step 406. If there are no scenes stored, the all selection dubbing process is finished at step 415 and the process returns to the initial navigation screen.

At step 406, if there are scenes stored in the HDD 15, determination is made as to whether a DVD is inserted into the DVD drive 16 at step 407. If the DVD is not inserted (“No” in step 406), a message of “dubbing scene is not available,” for example, is displayed and the process returns to step 322 in FIG. 3.

At step 407, if the DVD is inserted into the DVD drive 16, the DVD is recognized and DVD information on its type, protection state and residual capacity is collected at step 409 to automatically determine as to whether the loaded DVD is a disk on which data can be recorded at step 410. If the loaded DVD is a DVD without a residual capacity or a DVD such as a read only memory (ROM) or a DVD-ROM on which data cannot be recorded by a video camera, a message of “No residual capacity is left on DVD” or “This DVD cannot be used,” for example, is displayed and then the process returns to step 322.

At step 410, if the loaded DVD is a disk on which data can be recorded, determination is made as to whether the loaded DVD has already been formatted (initialized) at step 411.

At step 411, if the loaded DVD has not yet been formatted (initialized), a DVD initialization confirmation screen in FIG. 19 is displayed to ascertain whether to initialize the DVD at step 416. The central portion of the DVD initialization confirmation screen provides a DVD initialization confirmation display 2005 to ascertain whether to initialize the DVD. An operation guide 2002 at the lower portion of the screen displays a decision button icon for determining whether to initialize the DVD. If a user does not want to initialize the DVD in the DVD initialization confirmation screen, selecting “No” of the DVD initialization confirmation display 2005 by the cursor button 2707 and determining at step 417 finishes the all selection dubbing process at step 415, returning to the initial navigation screen.

Selecting “Yes” of the DVD initialization confirmation display 2005 by the cursor button 2707 and determining at step 417 displays a screen indicating that a DVD is being initialized at step 418. At step 419, determination is made as to whether an error is caused while the DVD is being initialized. If an error is caused, a DVD initialization failure screen indicating failure in initialization is displayed at step 420. The all selection dubbing process is finished at step 415 to return to the initial navigation screen.

If it is determined that an error is not caused while the DVD is being initialized at step 419, the process returns to step 402 to start the dubbing advance checking process.

If it is determined that the DVD has already been formatted at step 411, determination is made as to whether the DVD loaded at step 412 is released from protection. If the DVD is protected, an all selection dubbing process is finished at step 415 to return to the initial navigation screen. A message of “Do you want DVD to be released from protection?”, for example, may be displayed instead of returning to the navigation screen. If the DVD is released from protection, the process may proceed to step 413. The message may be displayed at steps 413 and 414 with the protection of the DVD memorized at step 412.

If the loaded DVD has been released from protection at step 412, determination is made as to whether data of the leading scene stored in the HDD 15 is less than 1.4 GB at step 413. If it is 1.4 GB or more, a message of, for example, “Leading scene is too large in capacity. Divide the scene” is displayed. The all selection dubbing process is finished at step 415 to return to the initial navigation screen. The reason why determination is made whether data is less than 1.4 GB is that one layer of an 8-cm DVD-RAM inserted into the DVD drive 16 is 1.4 GB in recording capacity, so that the data of a leading scene of 1.4 GB or more cannot be dubbed. If DVDs different in recording capacity are used, the value of 1.4 GB may be changed. Furthermore, the correspondence of the kinds of DVDs (including the number of layers) with their respective maximum recording capacities may be memorized in a table to change the value of 1.4 GB according to the kinds of DVDs. A BD and HD-DVD are also applicable. It is not limited to an 8-cm disk. A scene division screen is displayed instead of retuning to the navigation screen.

If it is determined that the data of a leading scene stored in the HDD 15 is less than 1.4 GB at step 413, the dubbing advance checking process is finished at step 414 and the process proceeds to a dubbing scene automatic selection process of step 308.

(3-3) Dubbing Scene Automatic Selection Process

The dubbing scene automatic selection process at step 308 is described in detail with reference to FIG. 5. The start of the dubbing scene automatic selection process at step 501 initializes each value used in the dubbing scene automatic selection process at step 502. Where, the following values are taken to zero (0): scene numbers N of scene data stored in the HDD 15; the total capacity of selection scenes which is the total data quantity of the selected scenes; the number of the total programs (PG) of scene; the number of the total entry points (EP) of scene; the number of selection scenes M which is the number of selected scenes to be dubbed. The residual capacity of the DVD for determining whether scenes can be dubbed onto a DVD uses the residual capacity obtained when the loaded DVD is recognized (step 409).

At step 503, determination is made as to whether a second or following DVD is being subjected to dubbing. If no, that is to say, if a first DVD is being subjected to dubbing, the process advances to step 505. If yes, a new number of the scene dubbed at the previous dubbing process is substituted for a scene number N at step 504.

At step 505, the scene number N is incremented to be taken as a scene number (N+1). At step 506, the number of selection scenes M is incremented to be taken as the number of selection scenes (M+1).

At step 507, data on a scene of the scene number (N+1) on the HDD 15 is obtained. At step 508, the total capacity of selection scenes is taken to be the capacity of the scene number (N+1), the number of the total EPs of scene is taken to be the number of the EPs till the scene number (N+1), and the number of the total scene PGs of scene is taken to be the number of PGs till the scene number (N+1). At step 509, determination is made as to whether the number of selection scenes is less than two (2).

At step 509, if the number of selection scenes is less than two or if it is one, a dubbing total capacity check is performed at step 510 to determine as to whether the total capacity of selection scenes is less than the residual capacity of the DVD obtained at step 409. If the total capacity of selection scenes is greater than the residual capacity of the DVD, the data capacity of the leading scene is less than the residual capacity of the loaded DVD, so that dubbing is not enabled. For this reason, an error message screen indicating that dubbing is not enabled is displayed at step 513. The all selection dubbing process is finished at step 514 to return to the initial navigation screen. If the total capacity of selection scenes is not greater than the residual capacity of the DVD at step 510, determination is made as to whether the number of the total PGs of scene is 99 or less at step 511 and the number of the total EPs of scene is 999 or less at step 512. If the number of the total PGs of scene is 99 or less and the number of the total EPs of scene is 999 or less, the process returns to step 505 to determine as to whether the following scene can be selected as a dubbing scene. At steps 511 and 512, if the number of the total PGs of scene is greater than 99 and the number of the total EPs of scene is greater than 999, the error message screen indicating that dubbing is not enabled is displayed at step 513. The all selection dubbing process is finished at step 514 to return to the initial navigation screen.

At step 509, if the number of selection scenes is two or more and if the total capacity of selection scenes obtained at step 515 is not greater than the residual capacity of the DVD obtained at step 409, determination is made as to whether the number of the total PGs of scene is 99 or less at step 516 and the number of the total EPs of scene is 999 or less at step 517. If the number of the total PGs of scene is 99 or less and the number of the total EPs of scene is 999 or less, the process returns to step 505 to determine as to whether the following scene can be selected as a dubbing scene and take the scene number to be (N+2), and the number of selection scene is taken to be (M+2) at step 506. The steps 507 to 517 are repeated. If the total capacity of selection scenes obtained at step 515 is greater than the residual capacity of the DVD, the number of the total PGs of scene is greater than 99 at step 516 or the number of the total EPs of scene is greater than 999 at step 517, the scenes including until the previous (N−1)-th scene (increments with repetition) are selected as the scenes to be dubbed and N−1 is held as the dubbed scene number at step 518. At step 519, the dubbing scene automatic selection process is finished. The dubbing confirmation screen is displayed at step 309 in FIG. 3.

The dubbing scene automatic selection process in FIG. 5 is described in detail with reference to data in FIG. 2. The description of the number of the total PGs of scene and the number of the total EPs of scene is omitted herein. The residual capacity in the DVD to be used herein is taken to be 1.4 GB.

At step 503, dubbing is not being performed when a first DVD is loaded, so that the scene number is taken to be one (1) at step 505 and the number of the selection scene is taken to be one (1) at step 506. At step 507, a data quantity of 0.5 GB is obtained as a scene 1 (scene A). At step 507, the total capacity of selection scenes becomes 0.5 GB. The number of selection scenes is one (1) at step 509, so that, at step 510, the total capacity of selection scenes is not greater than the residual capacity of 1.4 GB obtained at step 409, the process therefore returns to step 505. The scene number is taken to be two (2) at step 505 and the selection scene number is taken to be two (2) at step 506. At step 507, a data quantity of 0.2 GB is obtained as a scene 2 (scene B). At step 507, the total capacity of selection scenes becomes 0.7 GB. The number of selection scenes is two (2) at step 509, so that, at step 515 the total capacity of selection scenes is not greater than the residual capacity of 1.4 GB obtained at step 409, the process therefore returns to step 505. The above is repeated at the scene numbers 3 and 4. The number of selection scenes is taken to be four (4) at step 506 when the scene number is four (4) at step 505. At step 507, a data quantity of 0.3 GB is obtained as a scene 4 (scene D). At step 507, the total capacity of selection scenes becomes 1.5 GB. Since the number of selection scenes is four (4) at step 509, at step 515, the total capacity of selection scenes is greater than the residual capacity of 1.4 GB obtained at step 409, so that the scenes A, B and C including until the scene number 3 (=4−1) are selected as the scenes to be dubbed at step 518 and three (3=4−1) is held as a dubbed scene number. At step 519, the dubbing scene automatic selection process is finished. The dubbing confirmation screen is displayed at step 309 in FIG. 3.

At step 322, it is ascertained that a second DVD is inserted and the disc cover is closed, after that the dubbing automatic selection process starts at step 308 following steps 306 and 307. At this point, the dubbing continues at step 503, so that at step 504 the dubbed scene number three (3) held at step 518 is substituted for a scene number. At step 505, the scene number is taken to be four (4) and the following steps 506 to 519 are repeated to select the scenes D, E, F and G as the scenes to be dubbed onto the second DVD.

Incidentally, other check items may be provided in FIGS. 4 and 5. For example, the video camera may be equipped with features allowing a user (during recording operations) to selectably choose different video resolutions (e.g., xtra or fine at a 720×480 resolution, or std at a 360×240 resolution), aspect ratios, etc., for different recording sessions, e.g., a user may select a “fine” high resolution to record a scene having a high level of detail; a wide 16:9 aspect ratio to record a panoramic scene, etc. Since images with aspect ratios of 16:9 and 4:3 in one title are not allowed to be recorded onto one video format (VF) standard DVD (in particular onto a DVD-R and DVD-RW), if the scenes stored in the HDD 15 include images with aspect ratios of 16:9 and 4:3, messages are displayed of, for example, “A part of scenes cannot be dubbed,” “Images different in aspect ratio are included,” “Different wide modes cannot be used in DVD-R” and “Different wide modes cannot be used in DVD-RW(VF).” After that, the process may return to the navigation screen, or a scene selection screen may be displayed in which a scene can be selected by a user. In the scene selection screen, a cursor may be placed on the leading scene. Placing the cursor on an image different in aspect ratio from the leading scene allows a user to easily realize which image is different in aspect ratio.

Even when various different picture quality modes in which the video camera has captured images (for example, standard mode, fine mode and extra mode) are included, the same process as that in aspect ratio may be used. That is to say, messages may be displayed of “A part of scenes cannot be dubbed,” “Images different in picture quality mode are included,” “Images different in moving-image picture quality cannot be dubbed onto DVD-R” and “Images different in moving-image picture quality cannot be dubbed onto DVD-RW (VF).” When a scene selection screen on which a user selects a scene is displayed, a cursor may be placed on an image different in aspect ratio from a leading scene. When a combination of the aspect ratio and picture quality mode does not meet the standard, a message may be displayed of, for example, “Scenes recoded in a moving-image picture quality “STD” and wide mode “On” are included.” When the HDD 15 is capable of compiling scenes different in picture quality, a message may be displayed of “Scenes different in picture quality are combined, so that they cannot be dubbed onto DVD-RW (VF).” When the numbers of the total PEs and EPs exceed the limit values thereof described in FIG. 5, a message may be displayed of, for example, “Scenes exceed recordable ones in number, so that they cannot be dubbed.”

The all selection dubbing process has been described above. The term “all selection” used in the above description refers to dubbing data of all the scenes stored in the HDD 51. An automatic process for selecting scenes dubbed onto only one DVD loaded into the video camera is similar to the above. In this case, step 318 can be eliminated and the process may advance from step 316 to step 324 or 311.

(3-4) Scene Designation Dubbing Process

Although the scene automatic selection process has been described above, a user may select scenes to be dubbed. In this case, executing “scene designation” on the navigation screen through operation at step 303 in FIG. 3 causes the process not to advance step 305, but a scene designation dubbing process is executed. FIG. 20 shows an example of a scene selection screen in which a user designates a scene.

As shown in FIG. 20, the central portion of the screen displays thumbnail pictures 3103 (A to G) of scenes, a red frame 3106 (printed in black in the figure) showing the scenes to be dubbed selected by a user, and a yellow frame 3104 (striped area in the figure) indicating the selected thumbnail picture. The red frame 3106 can be selected not to include a leading scene. A title bar 3101 at the upper portion of the screen displays “Dubbing (scene selection)” which is the title of the screen. Reference numeral 3107 denotes a capacity bar visually indicating the capacity of DVD. The left frame (slants descending toward the left) shows an estimated capacity of data already recorded into the DVD, the central frame (slants descending toward the right) shows an estimated capacity of the selected scenes provided with the red frame 3106 and the yellow frame 3104 and the right frame (blank) shows an estimated space capacity of the DVD capable of recording scenes exclusive of those recorded and selected. Displaying such a capacity bar allows a user to select scenes to be dubbed while considering the residual capacity of the DVD. This capacity bar may be displayed in FIG. 9, which enables a user to confirm in advance how much capacity in the DVD is required to record automatically selected scenes and how much capacity is used for dubbed data. An operation guide 3102 at the lower portion of the screen displays has a decision button icon for determining dubbing of the selected scene and an all selection releasing button for releasing all selected scenes.

The check process described in FIGS. 4 and 5 is executed also in the scene designation dubbing process. An error caused by including scenes different in system is described because the error is different from that in the all selection dubbing process.

The error caused by including scenes different in system means that aspect ratio and picture quality, for example, are different between scenes as described above. In the all selection dubbing process, if scenes different in aspect ratio and picture quality are included in the HDD 15 or in the all selection dubbing process, the message is displayed indicating that scenes different in aspect ratio and picture quality are included. In the scene designation dubbing process, it is preferable that the scene that a user has already selected (or, the scene with the red frame 3106 in FIG. 20) is compared with the selected scene (or, the scene with the yellow frame 3104 in FIG. 20) and a message shown in FIG. 20 is displayed if the scenes are different in aspect ratio or picture quality.

It is very user friendly to display a scene already selected and a scene that cannot be dubbed onto the currently loaded DVD in advance. There are some means for display; for example, providing an x-mark, changing color, and making selection impossible.

Second Embodiment

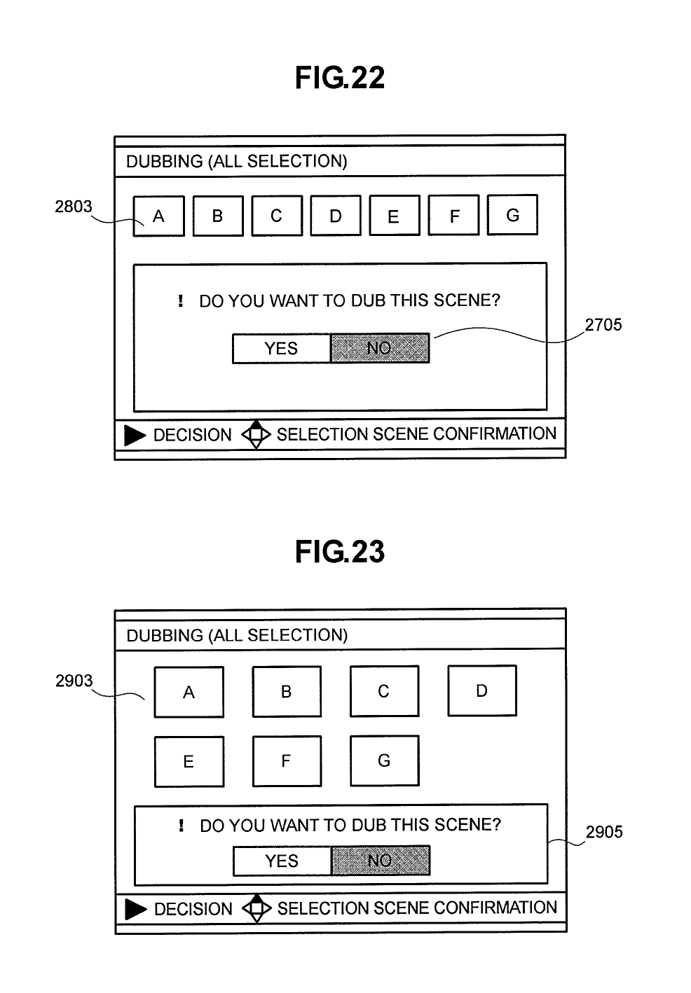

An example of a display of a dubbing confirmation screen preferable to the case where the number of scenes is large is illustrated in FIG. 22 as a second embodiment. The following description is centered on a part different from the counterpart in FIG. 8 which is an example of display of the first embodiment.

In the first embodiment, only four thumbnail pictures of scenes to be dubbed can be displayed in one screen at maximum, so that a display of dubbing scene confirmation shown in FIG. 9 has been provided. In the second embodiment, each thumbnail picture is reduced in size so that thumbnail pictures can be displayed according to the number of selected scenes. FIG. 22 shows thumbnail pictures 2803 A to G for the case where seven scenes A to G are selected. It is user friendly to display the screen in the above manner because a user can ascertain a large number of scenes to be dubbed on one screen.

If the number of the scenes to be dubbed is less than four, the display in FIG. 8 may be used. If the number of the scenes to be dubbed is four or more, the display in FIG. 8 may be changed to that in FIG. 22. This enables the scenes to be dubbed to be confirmed by larger thumbnail pictures if the number of the scenes is smaller and by smaller thumbnail pictures if the number of the scenes is larger, which is user-friendly.

Third Embodiment

Another example of a dubbing confirmation screen display preferable to the case where the number of the scenes is large is illustrated in FIG. 23 as a third embodiment. The following description is centered on a part different from the counterpart in FIG. 8 which is an example of display of the first embodiment.

The thumbnail picture 2903 in the third embodiment is equal in size to that in the first embodiment shown in FIG. 8. The dubbing confirmation display 2905 is reduced in size to allow eight thumbnail pictures at maximum to be displayed. It is user friendly to display the screen in the above manner because a user can ascertain a large number of scenes to be dubbed on one screen.

If the number of the scenes to be dubbed is less than four, the display in FIG. 8 may be used. If the number of the scenes to be dubbed is four or more, the display in FIG. 8 may be changed to that in FIG. 23.

Fourth Embodiment

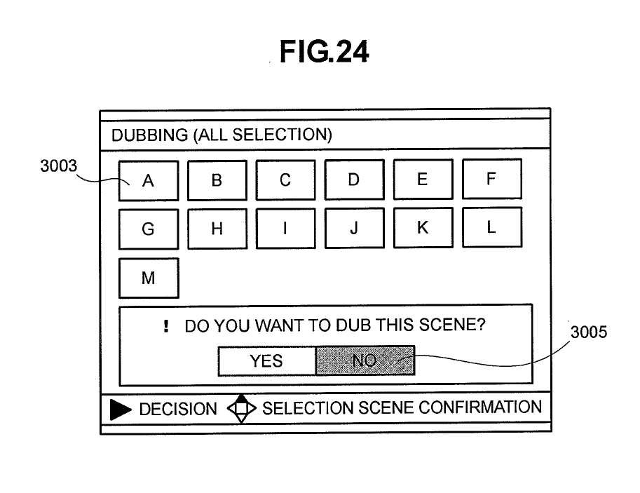

Another example of a dubbing confirmation screen display preferable to the case where the number of the scenes is large is illustrated in FIG. 24 as a fourth embodiment. The following description is centered on a part different from the counterpart in FIG. 8 which is an example of display of the first embodiment.

In the fourth embodiment, each thumbnail picture 3003 and the dubbing confirmation display 3005 are reduced in size to enable displaying the thumbnail pictures of the scenes to be dubbed on one screen according to the number of selection scenes. It is user friendly to display the screen in the above manner because a user can ascertain a large number of scenes to be dubbed on one screen.

If the number of the scenes to be dubbed is less than four, the display in FIG. 8 may be used. If the number of the scenes to be dubbed is four or more, the display in FIG. 8 may be changed to that in FIG. 24. This enables the scenes to be dubbed to be confirmed by larger thumbnail pictures if the number of the scenes is smaller and by smaller thumbnail pictures if the number of the scenes is larger.

The first to fourth embodiments have been described above.

Although the thumbnail pictures of the scenes to be dubbed and the dubbing confirmation display are displayed on the same screen in the dubbing confirmation screen display at step 309 in the above embodiments, both of the thumbnail pictures and the dubbing confirmation display may be separately displayed. For example, at step 309, thumbnail pictures are displayed for a predetermined time period and thereafter may be changed to the dubbing confirmation display.

Although dubbing is enabled by supplying power only from an AC adaptor, it is enabled by supplying power from a battery. If the number of scenes to be dubbed is small, power consumption is also small, so that dubbing hardly stops in the midst. It is preferable that a time period required for dubbing is compared in advance with a battery operable time period, and if the battery operable time period is longer than the dubbing time period, dubbing is allowed to start. It is also preferable that dubbing is allowed if a battery still holds a predetermined charge. This permits dubbing even if an adaptor is not available.

For button operations during dubbing, it is desirable that operations are not allowed by the recording button, stop button, or power-off switch during dubbing.

In the dubbing scene automatic selection process in FIG. 5, although scenes are selected based on the total capacity of selection scenes, the number of the total PGs and the number of the total EPs, scenes may selected based on other conditions such as dates the scenes were picked up, for example, scenes picked up on the same day and enabled to be recorded onto one DVD, or a combination of the above. For example, it is allowable that depressing the dubbing button 201 once executes the process in FIG. 5 and depressing it twice selects a scene picked up on the same day and enabled to be recorded onto one DVD.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

At least a portion (if not all) of the present invention may be practiced as a software invention, implemented in the form of one or more machine-readable medium having stored thereon at least one sequence of instructions that, when executed, causes a machine to effect operations with respect to the invention. With respect to the term “machine”, such term should be construed broadly as encompassing all types of machines, e.g., a non-exhaustive listing including: computing machines, non-computing machines, communication machines, etc. With regard to the term “one or more machine-readable medium”, the sequence of instructions may be embodied on and provided from a single medium, or alternatively, differing ones or portions of the instructions may be embodied on and provided from differing and/or distributed mediums. A “machine-readable medium” includes any mechanism that provides (i.e., stores and/or transmits) information in a form readable by a machine (e.g., a processor, computer, electronic device). Such “machine-readable medium” term should be broadly interpreted as encompassing a broad spectrum of mediums, e.g., a non-exhaustive listing including: electronic medium (read-only memories (ROM), random access memories (RAM), flash cards); magnetic medium (floppy disks, hard disks, magnetic tape, etc.); optical medium (CD-ROMs, DVD-ROMs, etc); electrical, optical, acoustical or other form of propagated signals (e.g., carrier waves, infrared signals, digital signals); etc.

In concluding, reference in the specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment or component, it is submitted that it is within the purview of one skilled in the art to effect such feature, structure, or characteristic in connection with other ones of the embodiments and/or components. Furthermore, for ease of understanding, certain method procedures may have been delineated as separate procedures; however, these separately delineated procedures should not be construed as necessarily order dependent in their performance, i.e., some procedures may be able to be performed in an alternative ordering, simultaneously, etc. Further, unless indicated otherwise, any of the specific procedures may be effected in real-time during operation of any apparatus and/or method.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A recording and reproducing apparatus comprising:
a reproducing module which reproduces information from a first recording medium;
a recording module which records information on a second recording medium;
a selecting module which selects information to be dubbed onto the second recording medium out of information in the first recording medium according to format mode compatibility with the second recording medium when information is dubbed from the reproducing module onto the recording module; and
a confirming module which displays information selected by the selecting module to allow confirmation of the information.

2. The recording and reproducing apparatus according to claim 1, wherein the selecting module selects information in order of recording on the first recording medium according to the capacity of the second recording medium.

3. The recording and reproducing apparatus according to claim 1, wherein the selecting module selects information not greater than the predetermined number of entry points or the predetermined number of programs.

4. The recording and reproducing apparatus according to claim 1, wherein the selecting module determines as to whether information recorded on first recording medium can be recorded on various kinds of the second recording media.

5. The recording and reproducing apparatus according to claim 4, wherein dubbing is restrained if a DVD-R or a DVD-RW/VF mode is used as the second recording medium when images different in picture quality or images different in aspect ratio are included in the information recorded in the first recording medium.

6. The recording and reproducing apparatus according to claim 1, wherein the selecting module determines whether both first and second information selected out of information recorded on first recording medium can be recorded on the second recording medium.

7. The recording and reproducing apparatus according to claim 6, wherein the selecting module prohibits the second information from being dubbed when the first and the second information are different in picture quality or aspect ratio from each other.

8. The recording and reproducing apparatus according to claim 1, including a deleting confirmation module which confirms whether information selected by the selecting module is deleted after the information is dubbed.

9. The recording and reproducing apparatus according to claim 1, including a continuous confirmation module which confirms whether at least a part of second information is dubbed when first information selected by the selecting module is dubbed and the second information except the first information exists in the first recording medium.

10. The recording and reproducing apparatus according to claim 1, wherein the selecting module selects information to be dubbed onto the second recording medium out of the second information when the first information selected by the selecting module is dubbed and the second information except the first information exists in the first recording medium, and
the confirming module displays information selected by the selecting module out of the second information to allow confirmation of the information.

11. The recording and reproducing apparatus according to claim 1, including:
an image pickup module which picks up images;
a recording module which records audio messages; and
a power supply module which charges electric power.

12. The recording and reproducing apparatus according to claim 11, including a dubbing button which executes the selecting module by depression thereof, and the confirming module which displays the above when it is detected that the dubbing button is depressed while images are being picked up by the image pickup module.

13. The recording and reproducing apparatus according to claim 11, including a power supply monitoring module which restrains the selecting module from selecting dubbing information when power is not input from an AC power supply different from the power supply module.

14. A recording and reproducing apparatus comprising:
a reproducing module which reproduces information from a first recording medium;
a recording module which records information on a second recording medium; and
a selecting module which selects information to be dubbed onto the second recording medium out of information in the first recording medium according to format mode compatibility with the second recording medium when information is dubbed from the reproducing module onto the recording module;
where the selecting module determines whether both first and second information selected out of information recorded on first recording medium can be recorded on the second recording medium.

15. A video camera comprising:
an image pickup module which picks up images;
a recording module which records audio messages;
a first recording module which records images on a built-in first recording medium;
a second recording module which records images on a replaceable second recording medium; and
a dubbing display module which displays a plurality of images which can be dubbed from the first recording medium to the single second recording medium.

16. A reproducing apparatus comprising:
a reproducing module which reproduces information from a first recording medium;
a selecting module which selects information to be dubbed onto a second recording medium out of information in the first recording medium according to format mode compatibility with the second recording medium used for dubbing when information is dubbed from the reproducing module onto recording module; and
a confirming module which displays information selected by the selecting module to allow confirmation of the information.

17. A recording apparatus comprising:
a recording module which records information on a recording medium;
a selecting module which selects information to be dubbed onto the second recording medium according to format mode compatibility with the second recording medium; and
a confirming module which displays information selected by the selecting module to allow confirmation of the information.

18. A recording and reproducing apparatus comprising:
a reproducing module which reproduces information from a first recording medium;
a recording module which records information on a second recording medium; and
a selecting module which selects information to be dubbed onto the second recording medium out of information in the first recording medium when information is dubbed from the first recording medium onto the second recording medium,
wherein, when information in different formats is recorded on the first recording medium and information is dubbed on the second recording medium in a predetermined mode, selecting by the selecting module is restrained so that information in the same format is selected.

19. A recording and reproducing apparatus according to claim 18, comprising a dubbing button which executes the selecting module by one time depression thereof, whereby the selecting module starts automatically selecting information to be dubbed onto the second recording medium out of information in the first recording medium.

20. A recording and reproducing apparatus according to claim 18, wherein the predetermined mode is a video format (VF) standard.

21. A recording and reproducing apparatus according to claim 18, wherein the format is an aspect ratio or a resolution.

22. A recording and reproducing apparatus according to claim 18, including a confirming module which displays information selected by the selecting module to allow confirmation of the information.

23. The recording and reproducing apparatus according to claim 18, including a continuous dubbing confirmation module which allows confirmation of continuous next dubbing if there is information which is not yet dubbed from the first recording medium after previous dubbing is finished.

24. A recording and reproducing apparatus comprising:
a reproducing unit adapted to reproduce information from a first recording medium;
a recording unit adapted to record information on a second recording medium, where the second recording medium is a different medium type than the first recording medium;
a dubbing selector unit adapted to automatically select and display candidate information selected to be dubbed onto the second recording medium out of information in the first recording medium, where the dubbing selector unit is adapted to select information having a format compatible with a format of the second recording medium, as the candidate information.

25. A recording and reproducing apparatus as claimed in claim 24, comprising:
a confirmation unit adapted to allow a user to authorize dubbing of the candidate information onto the second recording medium, responsive to the display of the candidate information.

26. A recording and reproducing apparatus as claimed in claim 24, wherein the format considered is at least one of: an aspect ratio; a resolution; and a video information format.

27. A recording and reproducing apparatus as claimed in claim 24, wherein if a selected candidate information has finished dubbing onto the second recording medium, and information remains on the first recording medium which has not been dubbed, the dubbing selector unit is adapted to automatically repeat the automatically select and display of candidate information selected to be dubbed onto a next second recording medium, out of information in the first recording medium which has not been previously dubbed.
